(19) United States
(12) Patent Application Publication
(10) Pub. No.: US 2025/0011187 A1
(43) Pub. Date: Jan. 9, 2025

(54) METHOD FOR SYNTHESIZING DYSPROSIUM-DOPED COBALT-CHROMATE FOR SUPERCAPACITOR APPLICATIONS AND A COMPOSITION FOR THE SAME

(71) Applicants: CENTRAL LABS, Abha (SA); KING KHALID UNIVERSITY, Abha (SA)

(72) Inventors: Mohd UBAIDULLAH, Ludhiana (IN); Mohd SHKIR, Abha (SA); S.M. AL-MOAYID, Abha (SA); Hamed Majdooa ALGARNI, Abha (SA); Haitham Elhosiny ALI, Abha (SA); Yasmin KHAIRY, Abha (SA); Jagadeesha Angadi V, Hubli (IN); Anuj KUMAR, Mathura (IN); Bidhan PANDIT, Leganés (ES)

(73) Assignees: CENTRAL LABS, Abha (SA); KING KHALID UNIVERSITY, Abha (SA)

(21) Appl. No.: 18/886,612

(22) Filed: Sep. 16, 2024

(51) Int. Cl. C01G 51/00

(52) U.S. Cl. CPC C01G 51/006; C01P 2002/54; C01P 2002/72; C01P 2004/64; C01P 2004/84; C01P 2006/40

(57) ABSTRACT

The present invention relates to a method for synthesizing dysprosium-doped cobalt-chromate for supercapacitor applications and a composition for the same, wherein an efficient and cost-effective Solution Combustion synthesis method is utilized for the preparation of Dy-doped CoCr₂O₄ (CCD). The stoichiometric dissolution of metal and rare earth nitrates, along with fuels, in distilled water forms a green-colored solution, subsequently heated to 450 degrees Celsius. The resulting ash undergoes grinding to yield a fine green pigment with a controlled size of 25 nm. Electrochemical properties of CCD are thoroughly examined through cyclic voltammetry, galvanostatic charge-discharge, and electrochemical impedance spectroscopy. Capacitive behavior, evaluated via various techniques, demonstrates an increase in capacitance with Dy³⁺ concentration. Density of states calculations reveal improved electronic features after Dy³⁺ doping, emphasizing enhanced charge storage capabilities. This invention provides insights into an advanced synthesis approach and the electrochemical potential of Dy-doped CoCr₂O₄ for energy storage applications.

### FIELD OF THE INVENTION

The present disclosure relates to a method for synthesizing dysprosium-doped cobalt-chromate for supercapacitor applications and a composition for the same.

### BACKGROUND OF THE INVENTION

Spinel materials are characterized by the formula AB₂O₄, where A represents a divalent cation and B a trivalent cation. These compounds exhibit a cubic structure with the Fdm-3m space group and offer three unique cation distributions: normal, random, or inverse, influencing their properties. Tetrahedral and octahedral sites in the spinel structure are occupied by A and B ions, respectively, with the potential for various colors, such as red, green, blue, and yellow.

Recent research has focused on rare earth-doped Cobalt Chromites (CoRxCr₂₋ₓO₄), showing promise in applications like sensors and catalysts. In this context, Co²⁺ populates tetrahedral sites (A), while Cr³⁺ and rare earth ions (R³⁺) reside in octahedral sites (B). The spinel structure's crystal field stability enhances its appeal for diverse applications based on transition metal ions, oxidation states, and their distribution within the structure.

Despite extensive exploration of the structural and magnetic properties of rare earth-doped Cobalt Chromites, a gap exists regarding the cyclic voltammetry (CV) performance and Density Functional Theory (DFT) analysis of Dy³⁺ doped CoCr₂O₄. In response, there is a need of an invention for synthesizing Dy³⁺ doped CoCr₂O₄, examining its structural, microstructural, and CV performance characteristics, with a particular focus on potential supercapacitor applications.

In the view of the foregoing discussion, it is clearly portrayed that there is a need of a method for synthesizing dysprosium-doped cobalt-chromate for supercapacitor applications and a composition for the same.

### SUMMARY OF THE INVENTION

The present disclosure relates to a method for synthesizing dysprosium-doped cobalt-chromate for supercapacitor applications and a composition for the same. The invention revolves around a comprehensive composition and method for synthesizing dysprosium-doped cobalt-chromate (CoDyₓCr₂₋ₓO₄) tailored for superior performance in supercapacitor applications. The composition consists of cobaltous nitrate, chromium nitrate, dysprosium nitrate, a fuel mixture of urea and glucose in a 1:1 ratio, and 25 milliliters of distilled water. The method involves dissolving these components in a glass beaker to form a solution, followed by stirring for 40 minutes until a green homogeneous solution is achieved. This solution undergoes a meticulous heating process in a box-type muffle furnace for 20-30 minutes, resulting in a green ash powder. The ash is then ground with a mortar, and the particles are dried through agitation in an agate mortar, followed by an hour-long grinding process. This produces a fine green pigment of CoDyₓCr₂₋ₓO₄, where the doping level (x) can be varied (e.g., x=0, 0.03, 0.05). Crucially, the method employs a fuel-assisted combustion process, where fuels facilitate the ignition of oxidizers at an appropriate temperature, leading to the formation of initial compounds with nano-sized crystallites. The homogeneous solution is heated at 450° C. under an inert atmosphere, a critical step to minimize oxidation and preserve the purity of the synthesized CoDyₓCr₂₋ₓO₄ nanoparticles. The dissolution of oxidizers and fuels in 25 milliliters of distilled water is carried out at room temperature to ensure proper mixing and solubility. The synthesized CoDyₓCr₂₋ₓO₄ nanoparticles exhibit a size preference of 25 nm, achieved through a combination of grinding with a mortar and sieving. Additionally, a user-defined quantity of the ground mixture can be compressed under pressure in a hydraulic press to achieve pelletization. An additional layer of versatility is introduced by the potential for post-synthesis treatments. This involves modifying or functionalizing the CoDyₓCr₂₋ₓO₄ nanoparticles to enhance specific capacitance, cycling stability, and rate capability, thereby optimizing their performance for advanced supercapacitor applications.

The present disclosure seeks to provide a composition for synthesizing dysprosium-doped cobalt-chromate for supercapacitor applications. The composition comprises: 20.04-20.22 wt. % of cobaltous nitrate; 54.22-55.52 wt. % of chromium nitrate; 0-1.21 wt. % of Dysprosium nitrate; 13.88-13.13.91 wt. % of Urea; and 10.41-10.43 wt. % of Glucose.

In an embodiment, the weight amount of the cobaltous nitrate, chromium nitrate, Dysprosium nitrate, Urea, and Glucose is 20.22%, 1.21%, 54.22%, 13.91%, and 10.43%, respectively.

The present disclosure also seeks to provide a method for synthesizing dysprosium-doped cobalt-chromate for supercapacitor applications. The method includes dissolving oxidizers and fuels in 25 milliliters of distilled water in a glass beaker to form a solution, wherein the oxidizers include 20.04-20.22 wt. % of cobaltous nitrate, 54.22-55.52 wt. % of chromium nitrate, and 0-1.21 wt. % of Dysprosium nitrate, and the fuel includes 13.88-13.13.91 wt. % of urea and 10.41-10.43 wt. % of glucose. The method further includes stirring the solution for 40 minutes using a magnetic stirrer until the solution is dissolved upon maintaining an 800 rpm to form a green color homogeneous solution. The method further includes heating the homogeneous solution for 20-30 minutes in a box-type muffle furnace to obtain a green powder in the form of ash. The method further includes grounding the ash with mortar to form powder. The method further includes drying particles of powder thereby agitating in an agate mortar and put through a grinding process that lasted one hour and resulted in the production of a fine green pigment of CoDyₓCr₂₋ₓO₄ (where, x=0, 0.03, 0.05).

In an embodiment, the fuels help the oxidizers to catch fire in presence of suitable temperature to form an initial compound with nano-size crystallites.

In an embodiment, the homogeneous solution is heated at 450° C. to form an ash of green color, wherein the heating of the homogeneous solution for 20-30 minutes in a box-type muffle furnace is conducted under an inert atmosphere to minimize oxidation and ensure the purity of synthesized CoDyₓCr₂₋ₓO₄ nanoparticles, wherein dissolution of oxidizers and fuels in 25 milliliters of distilled water is carried out at room temperature to ensure proper mixing and solubility.

In an embodiment, a user-defined quantity of a ground mixture is compressed under pressure in a hydraulic press to achieve pelletization.

In an embodiment, a size of the fine green pigment material is preferably 25 nm.

In an embodiment, a solution combustion technique is used to produce the fine green pigment of CoDyₓCr₂₋ₓO₄.

In an embodiment, the grinding of the ash with mortar is followed by sieving to achieve a desired particle size distribution of the CoDyₓCr₂₋ₓO₄ powder.

In an embodiment, the CoDyₓCr₂₋ₓO₄ nanoparticles are further modified or functionalized through post-synthesis treatments to enhance specific capacitance, cycling stability, and rate capability for improved supercapacitor performance.

An objective of the present disclosure is to provide a method for synthesizing dysprosium-doped cobalt-chromate for supercapacitor applications and a composition for the same.

Another objective of the present disclosure is to determine the optimal weight ratios of cobaltous nitrate, chromium nitrate, dysprosium nitrate, fuel, and distilled water for synthesizing CoDyₓCr₂₋ₓO₄, ensuring reproducibility and consistency in the production process.

Another objective of the present disclosure is to achieve controlled combustion during synthesis, where fuels aid oxidizers in catching fire at a suitable temperature, forming initial compounds with nano-sized crystallites, contributing to the desired properties of CoDyₓCr₂₋ₓO₄ for supercapacitor applications.

Another objective of the present disclosure is to develop a synthesis method that includes an inert atmosphere heating step at 450° C., minimizing oxidation during the production of the green powder, thereby ensuring the purity of CoDyₓCr₂₋ₓO₄ nanoparticles, crucial for enhancing the material's supercapacitor performance.

Another objective of the present disclosure is to optimize the size of the fine green pigment material to approximately 25 nm, ensuring a uniform and controlled particle size distribution, which can significantly impact the material's electrochemical properties in supercapacitors.

Yet, another objective of the present disclosure is to explore post-synthesis treatments to further modify or functionalize CoDyₓCr₂₋ₓO₄ nanoparticles, enhancing specific capacitance, cycling stability, and rate capability. This aims to improve the overall performance of CoDyₓCr₂₋ₓO₄ in supercapacitors and broaden its potential applications in energy storage systems.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a flow chart of a method for synthesizing dysprosium-doped cobalt-chromate for supercapacitors applications in accordance with an embodiment of the present disclosure;

FIG. 2 illustrates a graph representing XRD data of CoDyₓCr₂₋ₓO₄ (CCD) in accordance with an embodiment of the present disclosure;

FIG. 3 illustrates graphs representing (A) CV data at varying scan rates, (B) GCD data at varying current densities, (C) capacitance versus scan rate, and (D) capacitance versus current density for Dy-0.00, respectively in accordance with an embodiment of the present invention;

FIG. 4 illustrates graphs representing A) Nyquist plot of Z*, and (B & C) frequency dependences of Cₛ′ and Cₛ″ obtained from the impedance data for Dy-0.00, respectively in accordance with an embodiment of the present invention;

FIG. 5 illustrate graphs representing (A) CV data at varying scan rates, (B) GCD data at varying current densities, (C) capacitance versus scan rate, and (D) capacitance versus current density for Dy-0.03, respectively in accordance with an embodiment of the present invention;

FIG. 6 illustrate graphs representing (A) Nyquist plot of Z*, and (B & C) frequency dependences of Cₛ′ and Cₛ″ obtained from the impedance data for Dy-0.03, respectively in accordance with an embodiment of the present invention;

FIG. 7 illustrate graphs representing (A) CV data at varying scan rates, (B) GCD data at varying current densities, (C) capacitance versus scan rate, and (D) capacitance versus current density for Dy-0.05, respectively in accordance with an embodiment of the present invention; and

FIG. 8 illustrate graphs representing (A) Nyquist plot of Z*, and (B & C) frequency dependences of Cₛ′ and Cₛ″ obtained from the impedance data for Dy-0.05, respectively in accordance with an embodiment of the present invention;

FIG. 9 illustrates (a-b) Crystal structure and optimized supercell of CoCr₂O₄. (c-d) Crystal structure and optimized supercell of Dy³⁺ doped CoCr₂O₄. DOS of (e) CoCr₂O₄, and (f) Dy³⁺ doped CoCr₂O₄, respectively in accordance with an embodiment of the present invention;

FIG. 10 illustrates a Table depicting weight amounts of the composition for various concentration in accordance with an embodiment of the present invention; and

FIG. 11 illustrates a process flow of a method for synthesizing dysprosium-doped cobalt-chromate for supercapacitors applications in accordance with an embodiment of the present invention.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

The present invention provides a composition for synthesizing dysprosium-doped cobalt-chromate for supercapacitors applications. The composition comprises: 20.04-20.22 wt. % of cobaltous nitrate; 54.22-55.52 wt. % of chromium nitrate; 0-1.21 wt. % of Dysprosium nitrate; 13.88-13.13.91 wt. % of Urea; and 10.41-10.43 wt. % of Glucose.

In an embodiment, the weight amount of the cobaltous nitrate, chromium nitrate, Dysprosium nitrate, Urea, and Glucose is 20.22%, 1.21%, 54.22%, 13.91%, and 10.43%, respectively.

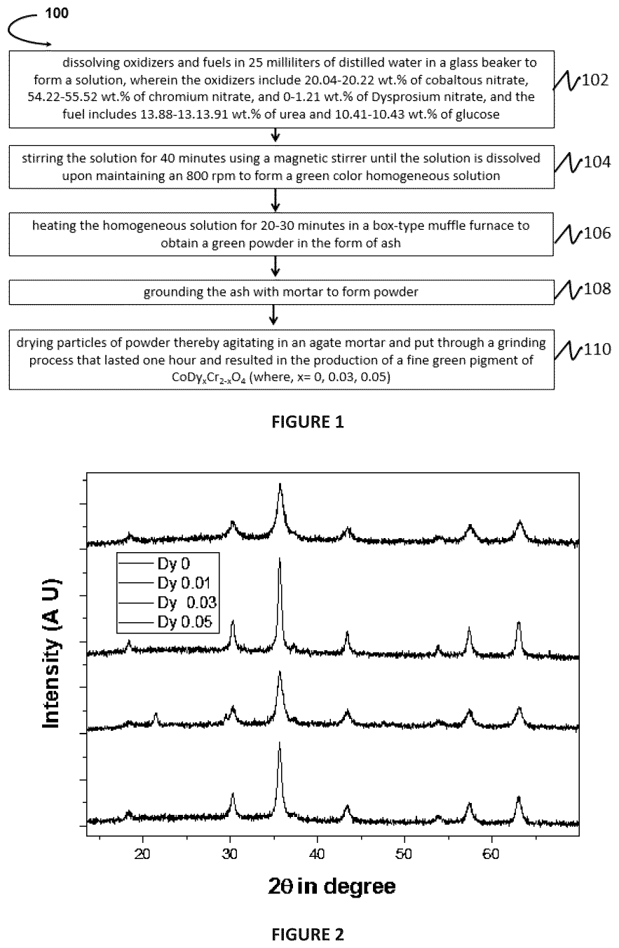

FIG. 1 illustrates a flow chart of a method for synthesizing dysprosium-doped cobalt-chromate for supercapacitors applications in accordance with an embodiment of the present disclosure.

Referring to FIG. 1, the method (100) includes a plurality of steps as described below,

At step (102) the method (100) includes dissolving oxidizers and fuels in 25 milliliters of distilled water in a glass beaker to form a solution, wherein the oxidizers include 20.04-20.22 wt. % of cobaltous nitrate, 54.22-55.52 wt. % of chromium nitrate, and 0-1.21 wt. % of Dysprosium nitrate, and the fuel includes 13.88-13.13.91 wt. % of urea and 10.41-10.43 wt. % of glucose.

At step (104) the method (100) includes stirring the solution for 40 minutes using a magnetic stirrer until the solution is dissolved upon maintaining an 800 rpm to form a green color homogeneous solution.

At step (106) the method (100) includes heating the homogeneous solution for 20-30 minutes in a box-type muffle furnace to obtain a green powder in the form of ash.

At step (108) the method (100) includes grounding the ash with mortar to form powder.

At step (110) the method (100) includes drying particles of powder thereby agitating in an agate mortar and put through a grinding process that lasted one hour and resulted in the production of a fine green pigment of CoDyₓCr₂₋ₓO₄ (where, x=0, 0.03, 0.05).

In an embodiment, the fuels help the oxidizers to catch fire in presence of suitable temperature to form an initial compound with nano-size crystallites.

In an embodiment, the homogeneous solution is heated at 450° C. to form an ash of green color, wherein the heating of the homogeneous solution for 20-30 minutes in a box-type muffle furnace is conducted under an inert atmosphere to minimize oxidation and ensure the purity of synthesized CoDyₓCr₂₋ₓO₄ nanoparticles, wherein dissolution of oxidizers and fuels in 25 milliliters of distilled water is carried out at room temperature to ensure proper mixing and solubility.

In an embodiment, a user-defined quantity of a ground mixture is compressed under pressure in a hydraulic press to achieve pelletization.

In an embodiment, a size of the fine green pigment material is preferably 25 nm.

In an embodiment, a solution combustion technique is used to produce the fine green pigment of CoDyₓCr₂₋ₓO₄.

In an embodiment, the grinding of the ash with mortar is followed by sieving to achieve a desired particle size distribution of the CoDyₓCr₂₋ₓO₄ powder.

In an embodiment, the CoDyₓCr₂₋ₓO₄ nanoparticles are further modified or functionalized through post-synthesis treatments to enhance specific capacitance, cycling stability, and rate capability for improved supercapacitor performance.

The present invention relates to Synthesis of Dy³⁺ doped CoCr₂O₄, wherein High purity analytical reagent grade precursors are used for the preparation of the samples with desired stoichiometry.

In an embodiment, the solution combustion technique involves maintaining the solution at a temperature range of 250° C. to 300° C. during the combustion process, promoting a controlled exothermic reaction between the oxidizers and fuels, and wherein the sieving process is carried out using a series of progressively finer mesh screens ranging from 50 μm to 10 μm to ensure a uniform particle size distribution of CoDyₓCr₂₋ₓO₄, with a final particle size of less than 25 nm. In this embodiment, the solution combustion technique is carefully regulated to maintain the solution within a specific temperature range of 250° C. to 300° C. during the combustion process. This controlled temperature management is critical to ensure a stable exothermic reaction between the oxidizers (such as cobaltous nitrate, chromium nitrate, and dysprosium nitrate) and the fuels (like urea and glucose). Maintaining this temperature range prevents the reaction from becoming too aggressive or explosive, which can lead to unwanted byproducts or inconsistent results. The gradual rise in temperature facilitates a uniform release of energy, allowing the components to react in a steady and predictable manner. The controlled exothermic reaction promotes the formation of CoDyₓCr₂₋ₓO₄ nanoparticles with precise chemical composition and minimal impurities.

Following the combustion process, the resulting ash is ground and subjected to a sieving process. This step is essential to achieve the desired particle size distribution. The sieving involves passing the ground ash through a series of progressively finer mesh screens, starting from 50 μm and going down to 10 μm. By using mesh screens with decreasing pore sizes, larger particles are systematically removed, ensuring that only fine particles, under 25 nm in size, remain in the final product. This sieving process is crucial to ensure the uniformity of the synthesized nanoparticles, which is particularly important for applications where consistent material properties, such as surface area or reactivity, are required. For example, in supercapacitor applications, the particle size directly influences the material's electrochemical performance, so achieving a uniform and fine particle size distribution enhances the overall effectiveness of the material. This embodiment ensures precision in both the combustion and particle refinement processes, which are key to producing high-quality CoDyₓCr₂₋ₓO₄ nanoparticles.

In an embodiment, the CoDyxCr2−xO4 nanoparticles are further modified or functionalized through post-synthesis treatments to enhance specific capacitance, cycling stability, and rate capability for improved supercapacitor performance, and wherein the stirring process of the solution for 40 minutes is performed with a variable-speed magnetic stirrer that automatically adjusts its rotational speed between 750 rpm and 800 rpm to maintain consistent homogeneity, further comprising monitoring the pH of the solution throughout the stirring process to ensure the optimal conditions for combustion synthesis. In this embodiment, the CoDyxCr2−xO4 nanoparticles, synthesized through solution combustion, undergo a post-synthesis modification or functionalization process aimed at enhancing their specific electrochemical properties—specifically, their capacitance, cycling stability, and rate capability.

This functionalization can involve various techniques, such as coating the nanoparticles with conductive polymers or carbon-based materials, doping with additional elements, or chemically treating the surface to create functional groups. For example, carbon nanotubes (CNTs) could be attached to the surface of the CoDyxCr2−xO4 nanoparticles to increase conductivity, which directly improves the charge-discharge rates in supercapacitor applications. Similarly, introducing additional dopants or surface treatments may enhance the electrochemical activity of the nanoparticles, enabling them to store and release charge more effectively. This post-synthesis modification ensures that the nanoparticles are not only structurally optimized but also possess the necessary surface characteristics for high-performance energy storage devices.

Additionally, the stirring process of the precursor solution prior to combustion synthesis plays a critical role in achieving consistent nanoparticle synthesis. In this embodiment, a variable-speed magnetic stirrer is employed to maintain consistent homogeneity in the solution. The stirrer operates within a range of 750 to 800 rpm, automatically adjusting its speed as needed. This automatic adjustment is particularly beneficial in preventing localized precipitation or the formation of inhomogeneous regions within the solution, which can occur if the stirring speed is not carefully controlled. For example, as the viscosity of the solution changes due to the dissolution of oxidizers and fuels, the stirrer compensates by increasing or decreasing its speed, ensuring continuous and uniform mixing.

In addition to the stirring speed, the pH of the solution is closely monitored throughout the 40-minute stirring process. Maintaining an optimal pH is essential for promoting proper combustion synthesis, as pH fluctuations can affect the solubility of the precursors and the reactivity of the fuels and oxidizers. By regularly monitoring and adjusting the pH, this embodiment ensures that the chemical environment remains ideal for the solution combustion process. For example, if the solution becomes too acidic or basic, it could hinder the combustion process or lead to incomplete reactions, resulting in impurities or uneven nanoparticle formation. Maintaining the right pH balance during stirring and preparation ensures that the CoDyxCr2−xO4 nanoparticles form under optimal conditions, leading to superior structural and electrochemical properties, particularly for supercapacitor performance.

In an embodiment, the method further comprising the step of pre-heating the glass beaker containing the solution at a temperature range of 50° C. to 60° C. prior to heating in the box-type muffle furnace, wherein the pre-heating step promotes the evaporation of excess water to increase the concentration of the oxidizers and fuels, thereby improving the combustion efficiency during the synthesis of CoDyₓCr₂₋ₓO₄, and wherein the box-type muffle furnace is equipped with a programmable temperature controller that gradually increases the temperature from room temperature to 450° C. over a period of 15 minutes, thereby minimizing thermal shock to the solution and promoting uniform combustion throughout the solution volume.

In this embodiment, the method incorporates a pre-heating step for the glass beaker containing the precursor solution before it is placed in the box-type muffle furnace for combustion. The beaker is pre-heated to a temperature range of 50° C. to 60° C. This preliminary heating step serves to promote the evaporation of excess water from the solution, thereby increasing the concentration of oxidizers and fuels. By concentrating these components, the combustion efficiency is improved during the subsequent synthesis of CoDyₓCr₂₋ₓO₄. For instance, pre-heating the solution reduces the initial water content, allowing for a more vigorous and controlled exothermic reaction once the solution is subjected to the higher temperatures in the furnace. This enhanced concentration helps ensure that the combustion reaction proceeds more efficiently, with a more consistent and complete transformation of the precursors into the desired CoDyₓCr₂₋ₓO₄ nanoparticles. Following pre-heating, the solution is transferred to the box-type muffle furnace, which is equipped with a programmable temperature controller. This furnace gradually increases the temperature from room temperature to 450° C. over a period of 15 minutes. The gradual temperature increase is designed to minimize thermal shock to the solution and the glass beaker. Rapid temperature changes could induce stress and result in uneven heating, which can negatively affect the uniformity of the combustion process and the quality of the final product.

By implementing a controlled and incremental heating rate, the furnace ensures that the solution is uniformly heated, promoting a consistent combustion reaction across the entire solution volume. For example, this controlled ramp-up minimizes the risk of localized overheating or incomplete combustion, which can lead to impurities or variations in particle size. This careful thermal management during the heating process is crucial for achieving high-quality CoDyₓCr₂₋ₓO₄ nanoparticles with desirable properties for applications such as energy storage, where uniformity and consistency are essential.

In an embodiment, the pre-heating of the glass beaker at 50° C. to 60° C. is performed using a laboratory hotplate with precise temperature control, wherein the solution is continuously stirred during pre-heating to prevent localized supersaturation of the oxidizers and ensure uniform precursor distribution prior to combustion, and wherein the magnetic stirrer used for stirring the solution is equipped with a temperature probe and feedback loop, automatically adjusting the stirring speed to maintain a constant solution viscosity, thus preventing phase separation or the formation of precipitates during the dissolution of the oxidizers and fuels.

In this embodiment, the pre-heating of the glass beaker containing the solution is carried out using a laboratory hotplate with precise temperature control, set to a range of 50° C. to 60° C. This step is crucial for evaporating excess water from the solution, which increases the concentration of the oxidizers and fuels, enhancing the combustion efficiency. The hotplate is chosen for its ability to accurately maintain the set temperature, ensuring that the solution is evenly pre-heated without significant temperature fluctuations.

During the pre-heating process, the solution is continuously stirred to avoid localized supersaturation of the oxidizers. This stirring ensures that the concentration of the oxidizers and fuels is uniformly distributed throughout the solution. By preventing localized areas of high concentration, the stirring helps to achieve a homogeneous mixture that will combust more consistently. For example, if the oxidizers were to settle or concentrate in one part of the solution, it could lead to uneven combustion and the formation of non-uniform nanoparticles. Continuous stirring during pre-heating mitigates this risk, preparing the solution for an even and controlled combustion reaction.

The magnetic stirrer used for stirring the solution is equipped with a temperature probe and a feedback loop system. This setup allows the stirrer to automatically adjust its speed in response to changes in the solution's viscosity. As the solution heats up and the concentration of dissolved substances increases, its viscosity can change. The feedback loop ensures that the stirring speed is adjusted accordingly to maintain a constant viscosity. This precise control prevents phase separation or the formation of precipitates, which could otherwise occur if the viscosity changes were not accounted for. For instance, if the stirring speed were not adjusted, the solution might become too viscous in certain areas, leading to inadequate mixing and potential formation of solid particles. By maintaining optimal stirring conditions, the magnetic stirrer ensures that the oxidizers and fuels remain well-dispersed and dissolved, which is crucial for achieving a uniform combustion reaction when the solution is transferred to the furnace.

In an embodiment, the user-defined quantity of the ground mixture is subjected to a multi-step compression process in the hydraulic press, with each step involving an incremental increase in pressure from 5 MPa to 15 MPa, followed by a cooling period between each compression step to improve the structural integrity of the resulting pellets, and wherein the solution is prepared in a controlled environment chamber that maintains a humidity level below 10% to prevent moisture interference with the oxidizers and fuels, thereby ensuring consistency in the combustion reaction during the synthesis of CoDyₓCr₂₋ₓO₄.

In this embodiment, the user-defined quantity of the ground CoDyₓCr₂₋ₓO₄ mixture undergoes a multi-step compression process in a hydraulic press. This method involves applying pressure incrementally, beginning at 5 MPa and increasing up to 15 MPa in controlled stages. Each compression step is followed by a cooling period to allow the material to stabilize, ensuring that the structural integrity of the pellets is preserved. This gradual increase in pressure, along with intermittent cooling, minimizes the risk of cracks or internal stress in the pellets. For example, by not subjecting the material to a single high-pressure compression, the process allows for better packing of the nanoparticles, which enhances the mechanical strength and uniformity of the resulting pellets. This multi-step approach is particularly beneficial for applications where the structural cohesion of the pellets is critical, such as in supercapacitors or catalytic applications. Additionally, the preparation of the solution is conducted in a controlled environment chamber, where the humidity level is maintained below 10%. This controlled environment is crucial for preventing moisture interference during the dissolution and mixing of the oxidizers (e.g., cobaltous nitrate, chromium nitrate, and dysprosium nitrate) and fuels (e.g., urea and glucose). High humidity can lead to premature hydration of the chemicals, altering their reactivity and potentially leading to inconsistent combustion results. For instance, excess moisture could cause partial decomposition of the fuel or uneven distribution of oxidizers, which would negatively impact the quality of the CoDyₓCr₂₋ₓO₄ nanoparticles.

Maintaining low humidity ensures that the chemicals remain in their optimal reactive state, thus promoting consistency in the combustion process during synthesis. By controlling environmental factors such as humidity, this embodiment prevents moisture-related variability, ensuring that the combustion reaction proceeds uniformly throughout the solution. This consistent reaction is key to producing high-quality CoDyₓCr₂₋ₓO₄ nanoparticles with uniform properties, particularly for applications that require high precision, such as energy storage systems or sensors. The careful combination of controlled compression and environmental regulation in this embodiment leads to the reliable production of structurally sound and chemically consistent CoDyₓCr₂₋ₓO₄ pellets.

In an embodiment, the 25 nm size of the fine green pigment material is achieved by performing a multi-stage grinding process, each stage involving different mesh sizes of the agate mortar to sequentially reduce particle size, followed by air jet milling to achieve a uniform nanoparticle distribution with minimal agglomeration, and wherein the green ash formed in the muffle furnace is subjected to a post-synthesis annealing process in a tube furnace at a temperature of 500° C. under a reducing hydrogen atmosphere for 2 hours, enhancing the crystalline structure and reducing any remaining oxidized impurities in the CoDyₓCr₂₋ₓO₄ nanoparticles.

In this embodiment, the fine green pigment of CoDyₓCr₂₋ₓO₄ is precisely sized to 25 nm through a multi-stage grinding process. Initially, the grinding begins with an agate mortar using coarser mesh sizes to reduce the particle size. As the particles become finer, the mesh sizes are progressively decreased in subsequent stages. This methodical approach allows for the gradual and controlled reduction of particle size, minimizing the risk of over-grinding and ensuring a consistent size distribution. For example, initial grinding with a larger mesh might reduce the particles to micrometer sizes, while subsequent grinding with progressively finer meshes achieves nanoscale dimensions.

Following the multi-stage grinding, the material is subjected to air jet milling This milling process utilizes high-velocity air jets to further reduce the particle size and achieve a uniform nanoparticle distribution. Air jet milling is effective in breaking down any remaining agglomerates and ensuring that the particles are dispersed evenly. This step is crucial for achieving nanoparticles with minimal agglomeration, which is essential for applications requiring high surface area and reactivity.

Additionally, the green ash produced in the muffle furnace undergoes a post-synthesis annealing process. The annealing is performed in a tube furnace at a temperature of 500° C. under a reducing hydrogen atmosphere for a duration of 2 hours. This annealing step enhances the crystalline structure of the CoDyₓCr₂₋ₓO₄ nanoparticles by facilitating the formation of well-defined crystalline phases. The reducing hydrogen atmosphere helps to remove any remaining oxidized impurities that might be present in the nanoparticles after the initial combustion process. For instance, the hydrogen atmosphere reacts with and reduces oxides, thereby purifying the material and improving its overall quality. The annealing process not only refines the crystal structure but also helps in achieving the desired nanoparticle size and improving the performance characteristics of the final CoDyₓCr₂₋ₓO₄ product.

In an embodiment, the post-synthesis treatment includes functionalizing the CoDyₓCr₂₋ₓO₄ nanoparticles with carbon nanotubes (CNTs) via a wet chemical method, where the functionalization process is performed in an ultrasonicator bath for 60 minutes, thereby enhancing the electrochemical properties of the nanoparticles for improved energy storage applications, and wherein the homogeneous solution is heated at 450° C. in a muffle furnace with a controlled heating ramp rate of 5° C. per minute, ensuring that thermal decomposition of the oxidizers occurs uniformly, thereby minimizing the formation of unwanted byproducts during the synthesis of CoDyₓCr₂₋ₓO₄.

In an embodiment, the CoDyₓCr₂₋ₓO₄ nanoparticles undergo a post-synthesis treatment that includes functionalization with carbon nanotubes (CNTs). This functionalization is carried out using a wet chemical method, which involves dispersing the nanoparticles and CNTs in a suitable solvent. The mixture is then subjected to ultrasonication in a bath for 60 minutes. The ultrasonication process employs high-frequency sound waves to enhance the dispersion of CNTs and facilitate their integration with the CoDyₓCr₂₋ₓO₄ nanoparticles. This method ensures a thorough and uniform functionalization, which is crucial for enhancing the electrochemical properties of the nanoparticles. For instance, CNTs can significantly improve the electrical conductivity and surface area of the nanoparticles, making them more suitable for energy storage applications such as supercapacitors or batteries. The functionalized CoDyₓCr₂₋ₓO₄ nanoparticles exhibit improved performance characteristics, including higher specific capacitance and better cycling stability, owing to the synergistic effects of the CNTs and the nanoparticles.

Additionally, during the synthesis of CoDyₓCr₂₋ₓO₄, the homogeneous solution is heated in a muffle furnace at a temperature of 450° C. The heating process is controlled with a ramp rate of 5° C. per minute. This gradual and controlled heating is essential for the thermal decomposition of the oxidizers to occur uniformly. By increasing the temperature at a controlled rate, the risk of rapid or uneven decomposition is minimized. This uniform decomposition helps in achieving a consistent and high-quality product by reducing the formation of unwanted byproducts, such as incomplete or secondary reaction products that could compromise the purity and properties of the CoDyₓCr₂₋ₓO₄ nanoparticles. For example, a controlled heating ramp rate ensures that the oxidizers decompose in a manner that promotes the desired reactions and minimizes side reactions, leading to a more efficient synthesis process and a cleaner final product.

In an embodiment, the sieving process following the grinding of the ash is performed using a series of stainless steel sieves with decreasing mesh sizes from 100 μm to 25 μm, wherein the powder is passed through each sieve under vacuum conditions to minimize contamination and achieve a uniform particle size distribution, and wherein the annealing process in the tube furnace is carried out in a reducing atmosphere of 5% hydrogen and 95% argon, with a controlled gas flow rate of 50 sccm, ensuring that any residual oxygen in the CoDyₓCr₂₋ₓO₄ nanoparticles is fully reduced, thereby enhancing the phase purity of the final product.

In this embodiment, after the grinding of the ash, the sieving process is meticulously performed using a series of stainless steel sieves with progressively finer mesh sizes ranging from 100 μm to 25 μm. This sequential sieving process is crucial for achieving a uniform particle size distribution of the CoDyₓCr₂₋ₓO₄ powder. The use of stainless steel sieves ensures durability and prevents contamination during sieving. To maintain high purity and prevent any contamination of the powder, the sieving is conducted under vacuum conditions. This vacuum-assisted sieving helps to remove any airborne particles that might otherwise mix with the powder, ensuring that only the desired particle sizes are collected and that the final product has a consistent and precise size distribution. For instance, the initial sieves with larger mesh sizes remove coarser particles, while the final sieve with a 25 μm mesh ensures that only the finest particles are retained.

Following the sieving process, the powder undergoes an annealing treatment in a tube furnace under a controlled reducing atmosphere. The annealing is conducted with a gas mixture consisting of 5% hydrogen and 95% argon, with a precise gas flow rate of 50 standard cubic centimeters per minute (sccm). This reducing atmosphere is critical for eliminating any residual oxygen that may be present in the CoDyₓCr₂₋ₓO₄ nanoparticles. The presence of residual oxygen can lead to unwanted oxidation of the nanoparticles, compromising their phase purity and overall quality. By using a reducing atmosphere, the hydrogen reacts with and removes the residual oxygen, ensuring that the nanoparticles are fully reduced and possess enhanced phase purity. The controlled gas flow rate maintains a steady and uniform reducing environment, further ensuring the effectiveness of the reduction process and the integrity of the final product.

In an embodiment, the sieving is conducted in a glove box under a nitrogen atmosphere to prevent exposure of the CoDyₓCr₂₋ₓO₄ powder to ambient air, thereby minimizing oxidation and ensuring the preservation of the material's phase purity during the sieving process. In this embodiment, the sieving process of the CoDyₓCr₂₋ₓO₄ powder is conducted within a glove box maintained under a nitrogen atmosphere. This controlled environment is essential for preventing the exposure of the powder to ambient air, which can lead to oxidation and degradation of the material. The glove box, equipped with an inert nitrogen atmosphere, creates a sealed environment that protects the CoDyₓCr₂₋ₓO₄ powder from moisture and oxygen, which are known to adversely affect the phase purity and overall quality of the nanoparticles.

By conducting the sieving process in this nitrogen atmosphere, the risk of oxidation is significantly reduced. Oxidation can introduce unwanted impurities and alter the chemical composition of the nanoparticles, potentially compromising their performance in various applications. The nitrogen atmosphere effectively prevents these oxidative processes by displacing oxygen and moisture, thus preserving the integrity and phase purity of the CoDyₓCr₂₋ₓO₄ powder throughout the sieving process.

For example, in a glove box, the powder is carefully transferred through the series of sieves while maintaining the inert nitrogen environment. This approach ensures that only the intended particle sizes are retained, and the material remains in its optimal state, free from any contamination or oxidation. The nitrogen atmosphere not only safeguards the material but also maintains the consistency of the powder's properties, ensuring that the final product is suitable for high-performance applications where phase purity and material integrity are crucial.

In an embodiment, the grinding process includes an intermediate heating step, wherein the ground powder is heated to 150° C. for 30 minutes between each grinding stage to eliminate moisture and prevent agglomeration of nanoparticles, ensuring a consistent reduction in particle size at each stage, and wherein the 40-minute stirring process is followed by a rest period of 10 minutes at room temperature, during which the solution is allowed to settle, promoting complete dissolution of any remaining solid particles and ensuring uniform precursor distribution before heating.

In this embodiment, the grinding process of the CoDyₓCr₂₋ₓO₄ powder incorporates an intermediate heating step to enhance the efficiency and consistency of particle size reduction. After each stage of grinding, the ground powder is subjected to heating at 150° C. for 30 minutes. This intermediate heating step serves a dual purpose: it helps to eliminate any residual moisture that may be present in the powder and prevents the agglomeration of nanoparticles, which can occur due to moisture absorption. By removing moisture, the particles remain separate and discrete, which ensures that the subsequent grinding stages result in a more uniform reduction in particle size. For example, if the powder exhibits moisture-related clumping, heating to 150° C. will effectively dry it out, leading to a finer and more consistent particle distribution after grinding.

Additionally, the stirring process of the precursor solution is followed by a rest period of 10 minutes at room temperature. During this rest period, the solution is allowed to settle, which promotes the complete dissolution of any remaining solid particles and ensures a uniform distribution of the precursor materials. This settling phase is crucial for achieving homogeneity in the solution before proceeding to the heating stage. For instance, after 40 minutes of stirring at an adjustable speed, any solid particles that were not fully dissolved can settle out, allowing for a more thorough and even mixing of the oxidizers and fuels. This ensures that the precursor solution is well-prepared for the subsequent heating process, minimizing the risk of incomplete reactions or uneven combustion.

In an embodiment, the functionalization of the CoDyₓCr₂₋ₓO₄ nanoparticles is performed by covalently attaching amino-functional groups to the nanoparticle surface using a silanization process, wherein the nanoparticles are suspended in ethanol and treated with 3-aminopropyltriethoxysilane (APTES) under nitrogen atmosphere for 2 hours at 60° C., enhancing the material's supercapacitor performance, and wherein the cobaltous nitrate, chromium nitrate, and dysprosium nitrate are dissolved in the distilled water in a sequential manner, with each nitrate being added incrementally over a period of 5 minutes while stirring, ensuring proper solubility of each nitrate before adding the next to avoid precipitation or unwanted side reactions.

n this embodiment, the functionalization of CoDyₓCr₂₋ₓO₄ nanoparticles is achieved through a silanization process, which involves the covalent attachment of amino-functional groups to the nanoparticle surfaces. This functionalization step is critical for enhancing the supercapacitor performance of the nanoparticles.

The process begins with the suspension of the CoDyₓCr₂₋ₓO₄ nanoparticles in ethanol, creating a stable environment for the chemical modification. To covalently bond amino-functional groups to the nanoparticle surfaces, 3-aminopropyltriethoxysilane (APTES) is used as the silanizing agent. The suspension of nanoparticles and APTES is maintained under a nitrogen atmosphere at 60° C. for 2 hours. The use of nitrogen prevents moisture and oxygen from interfering with the reaction, ensuring that the silanization occurs efficiently and uniformly. APTES reacts with the surface of the nanoparticles, forming a stable covalent bond with the amino groups, which enhances their electrochemical properties. This modification improves the specific capacitance, cycling stability, and rate capability of the CoDyₓCr₂₋ₓO₄ nanoparticles, making them more effective for supercapacitor applications.

Simultaneously, the preparation of the precursor solution involves a meticulous sequential addition of cobaltous nitrate, chromium nitrate, and dysprosium nitrate into distilled water. Each nitrate is added incrementally over a period of 5 minutes while continuously stirring the solution. This incremental addition ensures that each nitrate dissolves completely and uniformly before the next one is introduced. By controlling the rate of addition and maintaining constant stirring, the risk of precipitation and unwanted side reactions is minimized. This careful approach helps in achieving a homogeneous precursor solution, which is crucial for the subsequent combustion synthesis of CoDyₓCr₂₋ₓO₄. Proper solubility of each nitrate ensures that the resulting nanoparticles have a consistent composition and high quality, contributing to the overall effectiveness of the final product.

In an embodiment, the ground mixture is compressed in a hydraulic press using a multi-stage process, where the pressure is applied in incremental steps of 2 MPa, pausing for 5 seconds between each pressure increase, to avoid micro-cracking of the pellets and to achieve a uniform pellet density. In an embodiment, the ground mixture is subjected to a multi-stage compression process using a hydraulic press. This method involves applying pressure incrementally in steps of 2 MPa. Each pressure increment is followed by a pause of 5 seconds, a technique designed to minimize the risk of micro-cracking in the resulting pellets. The incremental application of pressure helps in achieving a more uniform pellet density, as it allows for gradual compaction and ensures that the particles are evenly distributed within the pellet. This careful and controlled approach to compression is essential for producing high-quality pellets with consistent physical properties, which are crucial for the subsequent processing steps and the overall performance of the final product.

In an embodiment, the wet chemical method used to functionalize the CoDyₓCr₂₋ₓO₄ nanoparticles with carbon nanotubes involves a two-step process, wherein the nanoparticles are first coated with a polydopamine layer in an alkaline solution under magnetic stirring, followed by the attachment of the carbon nanotubes through π-π stacking interactions, enhancing the conductivity of the final material. In an embodiment, the functionalization of CoDyₓCr₂₋ₓO₄ nanoparticles with carbon nanotubes (CNTs) is accomplished using a two-step wet chemical method. Initially, the nanoparticles are coated with a polydopamine layer in an alkaline solution, where magnetic stirring ensures uniform coating. This layer serves as an intermediate matrix that enhances the adhesion of CNTs. Following the polydopamine coating, the carbon nanotubes are attached to the nanoparticles through π-π stacking interactions. This method of functionalization significantly enhances the electrical conductivity of the CoDyₓCr₂₋ₓO₄ nanoparticles, making them more suitable for applications such as supercapacitors where high conductivity is essential for improved performance.

In an embodiment, the heating of the homogeneous solution in the box-type muffle furnace is conducted in a stepwise manner, starting at 150° C. for 10 minutes to evaporate excess water, followed by an increase to 450° C. over the next 20 minutes, ensuring gradual combustion and reducing thermal stress on the solution during the synthesis of CoDyₓCr₂₋ₓO₄.

In an embodiment, the heating of the homogeneous solution in the box-type muffle furnace is executed in a stepwise manner to ensure optimal synthesis conditions. The process begins at a lower temperature of 150° C. for 10 minutes. This initial heating phase is specifically intended to evaporate any excess water present in the solution. After the initial phase, the temperature is gradually increased to 450° C. over the next 20 minutes. This stepwise increase in temperature helps to control the combustion process, reducing the likelihood of thermal stress and ensuring a more uniform and controlled reaction. The gradual heating approach is crucial for achieving a consistent and high-quality synthesis of CoDyₓCr₂₋ₓO₄, as it prevents rapid thermal changes that could otherwise lead to incomplete reactions or the formation of unwanted byproducts.

In an embodiment, the fine green pigment material of CoDyₓCr₂₋ₓO₄, having a particle size of 25 nm, is subjected to an additional ball milling process for 2 hours, using zirconia balls under nitrogen atmosphere, to achieve enhanced uniformity in particle size distribution and prevent oxidation during the milling process.

In this embodiment, the fine green pigment material of CoDyₓCr₂₋ₓO₄, with a particle size of 25 nm, undergoes an additional ball milling process to further refine its characteristics. The ball milling is conducted for 2 hours using zirconia balls, a choice that provides hardness and durability, essential for achieving a uniform particle size distribution. The milling process occurs under a nitrogen atmosphere, which is crucial for preventing oxidation of the nanoparticles during the process.

The use of zirconia balls in the milling process enhances the efficiency of size reduction and improves the uniformity of the particle size distribution. Zirconia, known for its high density and resistance to wear, ensures that the mechanical energy applied during milling is effectively transmitted to the CoDyₓCr₂₋ₓO₄ particles. This results in a more consistent particle size and better dispersion of the nanoparticles.

Maintaining a nitrogen atmosphere during the milling process is essential for preserving the integrity of the CoDyₓCr₂₋ₓO₄ nanoparticles. Nitrogen, an inert gas, prevents oxidation that could alter the chemical composition and degrade the properties of the nanoparticles. By avoiding exposure to oxygen, the process ensures that the final product retains its intended quality and performance characteristics.

The precursors employed in this synthesis include Co(NO₃)₂·4H₂O (Sigma Aldrich, purity 99.9%) with a molecular weight (MW) of 291.03 g/mol, Cr(NO₃)₂·6H₂O (Sigma Aldrich, purity 99.9%) with a MW of 400.15 g/mol, and Dy(NO₃)₃·5H₂O (Sigma Aldrich, purity 99.9%) with a MW of 348.51 g/mol, all serving as oxidizers. NH₂CONH₂ (Sigma Aldrich, purity 99.9%) with a MW of 60.6 g/mol and Glucose (Sigma Aldrich, purity 99.9%) with a MW of 180.156 g/mol are utilized as the fuel components for the combustion reaction.

Utilizing the solution combustion technique, the nanoparticles of Co(NO₃)₂·4H₂O are synthesized, where x=0, 0.03, 0.05. Stoichiometric amounts of cobaltous nitrate, chromium nitrate, and dysprosium nitrate were employed as oxidizers, while urea and glucose in a 1:1 ratio served as the fuel. The fuels played a crucial role in facilitating the ignition of oxidizers at an optimal temperature, leading to the formation of initial compounds with nano-sized crystallites. In a glass beaker, proportional quantities of oxidizers and fuels, determined by stoichiometric calculations, were combined with distilled water. The resulting solution underwent stirring for 40 minutes using a magnetic stirrer at 800 rpm, achieving a homogeneous solution. This homogeneous solution was subjected to heat treatment in a preheated box-type muffle furnace set at 450° C. for 20 minutes. The solution rapidly boiled upon introduction to heat, followed by frothing and subsequent ignition, resulting in the formation of ash within a remarkably short duration.

For the physical measurements related to supercapacitor properties, sodium sulfate (Na₂SO₄), poly (vinyl butyral) (PVB, Mw=150,000) from MilliporeSigma, Canada, multiwalled carbon nanotubes (MWCNTs) from Bayer, Germany, and nickel foams (Vale, Canada, porosity 96%, thickness 1.6 mm) were utilized.

The active materials (AM), namely Dy-0.00, Dy-0.01, Dy-0.03, and Dy-0.05, were mixed with MWCNTs and dissolved PVB binder in ethanol, maintaining an 80:20:3 ratio for active materials to MWCNTs. MWCNTs were incorporated to enhance conductivity. The resulting slurries underwent ultrasonic treatment for one hour in an ultrasonication bath. Subsequently, these slurries were used for impregnating Ni foam current collectors. Following the drying process, the total mass of the impregnated material was set at 40 mgcm⁻² for Dy samples and 35 mg cm⁻² for Rb samples. The electrode's total area was 1 cm². To enhance the connection between the active materials and the Ni foam current collector, the thickness of the current collector was reduced to 38% of its initial value.

A 0.5 M Na₂SO₄ electrolyte was employed for the experimentation. The electrodes underwent testing procedures, including “cyclic voltammetry” (CV), “electrochemical impedance spectroscopy” (EIS) using a PARSTAT 2273 potentiostat, and “galvanostatic charge-discharge” (GCD) with a “BioLogic VMP 300” potentiostat, prior to immersion in the electrolyte for examination. The potential window for both CV and GCD was set from 0 to 0.8 volts. EIS analysis involved applying a voltage amplitude of 5 mV across a frequency spectrum ranging from 10 mHz to 100 kHz.

An electrochemical cell, comprising a Na₂SO₄ electrolyte, a working electrode, a reference electrode, and a counter electrode made of platinum mesh, was utilized for these tests. The capacitances were determined using data obtained from CV, GCD, and EIS, employing the same methodology as detailed in previous investigations.

To explore the structures and electronic properties of CoCr₂O₄ and Dy³⁺ doped CoCr₂O₄, density of states (DOS) calculations were performed using the Quantum Espresso package. Initially, a 2×2×2 supercell was constructed for both CoCr₂O₄ and Dy³⁺ doped CoCr₂O₄.

Subsequently, self-consistent field (SCF) and DOS were computed employing a projector augmented-wave (PAW) potential in conjunction with the “generalized gradient approximation” (GGA) of the “Perdew-Burke-Ernzerhof” (PBE) functional terms.

Throughout the calculations, convergence standards were set at 0.05 eV for force and 10⁻⁵ eV for energy, all under an energy cut-off of 250 eV. The calculations utilized a k-grid of 4×4×4 points within the first Brillouin zone, following the Monkhorst-Pack approach.

FIG. 2 illustrates a graph representing XRD data of CoDyₓCr₂₋ₓO₄ (CCD) in accordance with an embodiment of the present disclosure.

The X-ray diffraction (XRD) profile indicated a spinel-type structure for CoDyₓCr₂₋ₓO₄ (CCD), as illustrated in FIG. 2. All observed reflection peaks for CoDyₓCr₂₋ₓO₄ aligned with a cubic structure and were assignable to a space group of Fd-3m (227), confirming the material's cubic nature. Specifically, diffraction peaks at 2θ values of 30.6, 35.88, 38.11, 43.87, 54.09, 60.16, 65.81, 78.55, and 79.11 corresponded to spinel oxide hkl lines (220), (311), and (222). These findings align with existing literature (JCPDS No. 81-0667), substantiating the consistency of the results. The absence of any impurity-related phases in the XRD pattern further affirmed the purity of CoDyₓCr₂₋ₓO₄ (CCD) for varying dopant levels (x=0, 0.03, and 0.05). Scherrer's equation was applied to estimate an average grain size of 22 nm, visually depicted in FIG. 2 through the simulated structure.

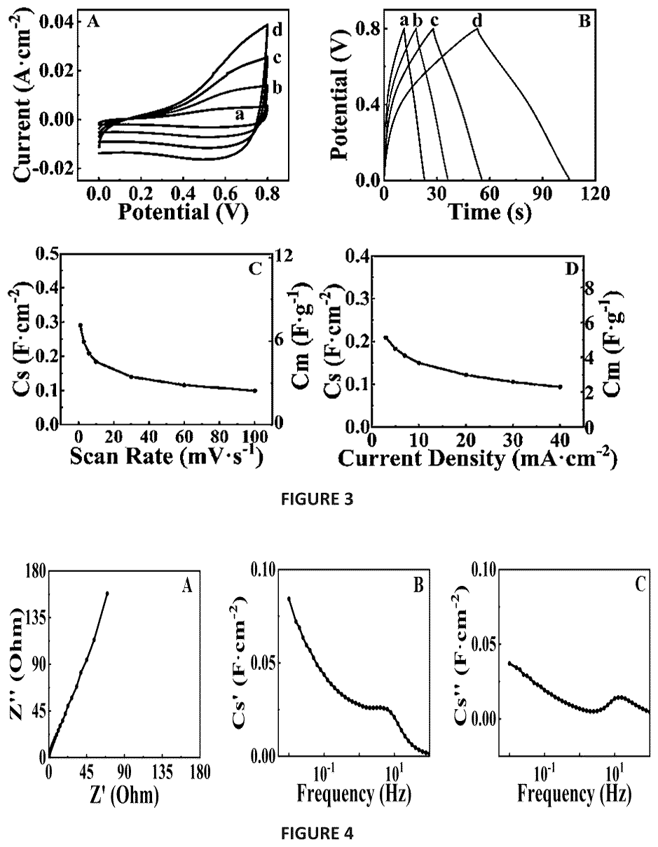

FIG. 3 illustrates graphs representing (A) CV data at varying scan rates, (B) GCD data at varying current densities, (C) capacitance versus scan rate, and (D) capacitance versus current density for Dy-0.00, respectively in accordance with an embodiment of the present invention.

Referring to FIG. 3, CV data is represented at scan rates of (a) 10 (b) 30 (c) 60 (d) 100 mV s⁻¹, and GCD data at current densities of (a) 3 (b) 5 (c) 7 and (d) 10 mA·cm⁻².

FIG. 4 illustrates graphs representing A) Nyquist plot of Z*, and (B & C) frequency dependences of Cₛ′ and Cₛ″ obtained from the impedance data for Dy-0.00, respectively in accordance with an embodiment of the present invention.

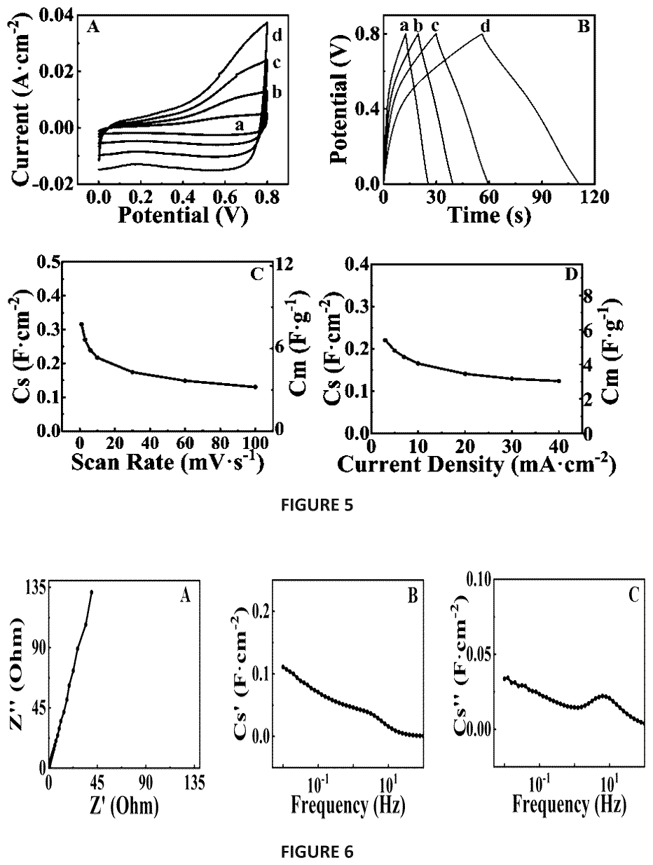

FIG. 5 illustrate graphs representing (A) CV data at varying scan rates, (B) GCD data at varying current densities, (C) capacitance versus scan rate, and (D) capacitance versus current density for Dy-0.03, respectively in accordance with an embodiment of the present invention.

Referring to FIG. 5, CV data is represented at scan rates of (a) 10 (b) 30 (c) 60 (d) 100 mV s⁻¹, and GCD data at current densities of (a) 3 (b) 5 (c) 7 and (d) 10 mA cm⁻².

FIG. 6 illustrate graphs representing (A) Nyquist plot of Z*, and (B & C) frequency dependences of Cₛ′ and Cₛ″ obtained from the impedance data for Dy-0.03, respectively in accordance with an embodiment of the present invention.

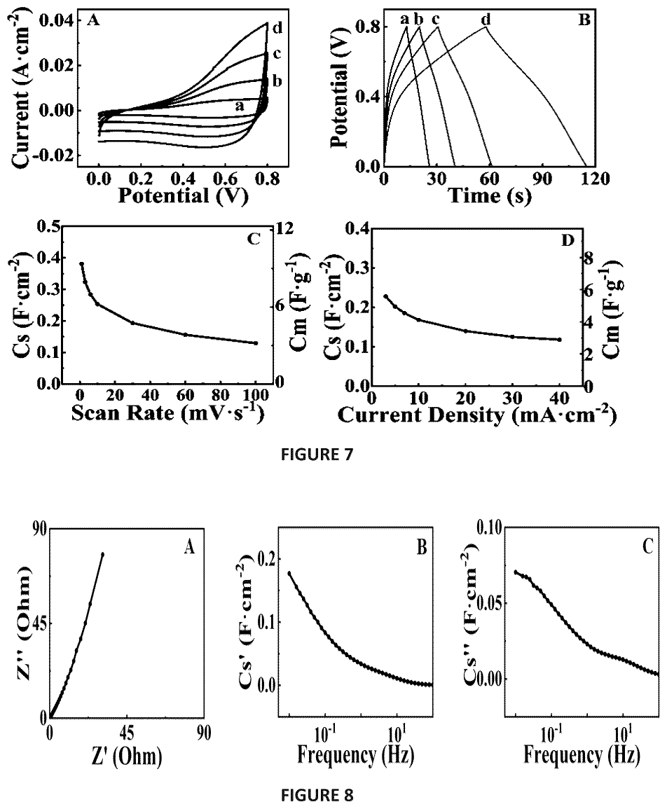

FIG. 7 illustrate graphs representing (A) CV data at varying scan rates, (B) GCD data at varying current densities, (C) capacitance versus scan rate, and (D) capacitance versus current density for Dy-0.05, respectively in accordance with an embodiment of the present invention.

Referring to FIG. 7, CV data is represented at scan rates of (a) 10 (b) 30 (c) 60 (d) 100 mV s⁻¹, and GCD data at current densities of (a) 3 (b) 5 (c) 7 and (d) 10 mA cm⁻².

FIG. 8 illustrate graphs representing (A) Nyquist plot of Z*, and (B & C) frequency dependences of Cₛ′ and Cₛ″ obtained from the impedance data for Dy-0.05, respectively in accordance with an embodiment of the present invention.

The capacitive behavior of the electrodes was assessed through cyclic voltammetry (CV) at varying scan rates, galvanostatic charge-discharge (GCD) at different constant current densities, and electrochemical impedance spectroscopy (EIS) at different frequencies. CV and GCD data indicated the capacitive nature of the tested electrodes, with capacitance decreasing as charge-discharge duration decreased.

In FIG. 3, FIG. 5, and FIG. 7, CV, GCD, and EIS data are presented for undoped sample Dy-0.00 and samples containing different amounts of Dy as dopants. Calculated capacitance values were 0.29, 0.32, and 0.38 F·cm⁻² for Dy-0.00, Dy-0.03, and Dy-0.05, respectively, based on CV testing results at a scan rate of 1 mV·s⁻¹. At a current density of 3 mA·cm⁻², the obtained capacitance values were 0.21, 0.22, and 0.23 F·cm⁻² for Dy-0.00, Dy-0.03, and Dy-0.05, respectively, based on GCD testing results.

Referring to FIG. 4, FIG. 6, and FIG. 8, the comparison of Nyquist plots depicting complex impedance reveals a decrease in the real part of impedance with increasing Dy content. This decline signifies an enhancement in conductivity, indicating improved charge storage capabilities. This aligns with the observed increase in capacitance with higher Dy content. Capacitances derived from CV and GCD data are consistent at comparable charge-discharge durations.

However, the real parts of capacitances obtained from the EIS data were lower than those calculated from CV and GCD data. It's noteworthy that CV and GCD data offer average integral capacitances within a 0.8 V voltage window, while EIS data provide differential capacitances measured at a low amplitude of AC signal and an open circuit potential. This suggests that at low voltages, certain redox-active sites may not have been accessible by the electrolyte, resulting in lower capacitances.

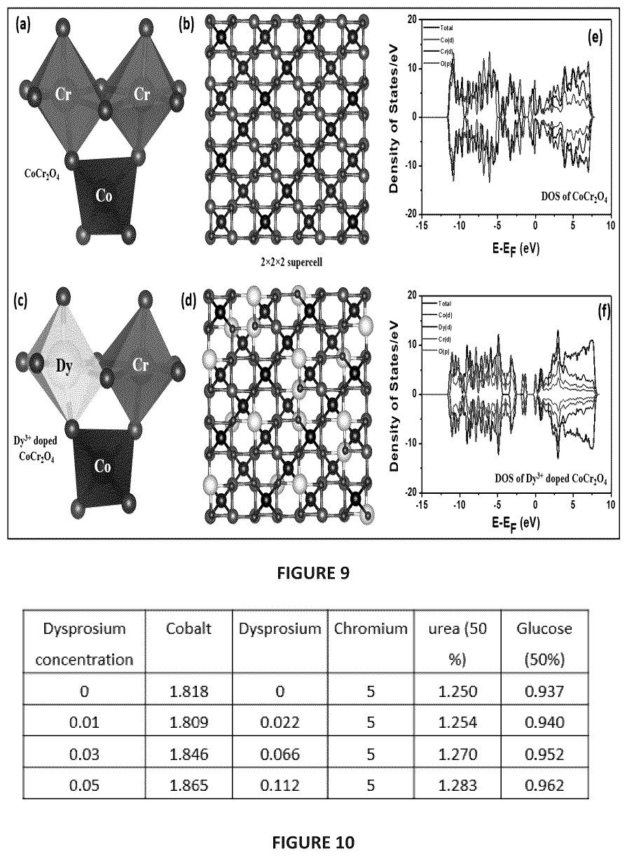

FIG. 9 illustrates (a-b) Crystal structure and optimized supercell of CoCr₂O₄. (c-d) Crystal structure and optimized supercell of Dy3+ doped CoCr₂O₄. DOS of (e) CoCr₂O₄, and (f) Dy3+ doped CoCr₂O₄, respectively in accordance with an embodiment of the present invention.

Density of states (DOS) calculations is conducted to investigate the impact of Dy3+ doping on the electrical characteristics of CoCr₂O₄.

Referring to FIG. 9(a-b) and 9(c-d), the crystal model and constructed supercell of CoCr₂O₄ and Dy3+ doped CoCr₂O₄ are illustrated, respectively. The calculated DOS for the constructed supercell of CoCr₂O₄ and Dy3+ doped CoCr₂O₄ (FIG. 9 (e-f)) displayed a noteworthy enhancement in DOS following Dy3+ doping. This improvement indicates an enhancement in the electronic characteristics of CoCr₂O₄, contributing positively to its electrochemical capabilities for charge storage.

The method for synthesizing involves an efficient and cost-effective preparation of Dy-doped CoCr2O4 using a Solution Combustion synthesis method for the first time. Stoichiometry dictates that metal nitrates, rare earth (Dy) nitrates, and fuels should be dissolved in 25 milliliters of distilled water with constant stirring until the solution becomes fully dissolved, developing a green color.

After complete dissolution, the solution is heated to 450 degrees Celsius and maintained at that temperature for half an hour to finalize the formation reaction, resulting in a green powder in the form of ash. Subsequently, the powder is removed and thoroughly ground with a mortar. Once the particles are completely dry, they undergo a grinding process in an agate mortar for one hour, yielding a fine green pigment.

A defined quantity of the ground mixture can be compressed under pressure in a hydraulic press to achieve pelletization.

The size of the material is maintained in the range of 25 nm.

The electrochemical properties of CCD are extensively investigated using cyclic voltammetry, galvanostatic charge-discharge, electrochemical impedance spectroscopy, and cyclic stability testing.

The behavior of capacitors is evaluated through cyclic voltammetry at various scan speeds, galvanostatic charge-discharge at different constant current densities, and electrochemical impedance spectroscopy at different frequencies. The capacitive behavior of the electrodes is demonstrated by their cyclic voltammetry and galvanostatic charge-discharge data.

The capacitance is calculated to be between 0.29 and 0.38 F cm−2, showing an increase with Dy3+concentration. At a scan rate of 1 millivolt per second, the capacitance values obtained are 0.21, 0.22, and 0.23 F cm−2, respectively, at a current density of 3 mA cm−2.

Comparing the Nyquist plots of complex impedance reveals a decrease in the real component of impedance with increasing Dy3+content, indicating an increase in conductivity beneficial for charge storage. This is supported by density of states calculations, showing a remarkable distribution across the Fermi level after Dy3+doping in CoCr2O4, suggesting improved electronic features.

In summary, the invention highlights the efficient synthesis method, electrochemical properties, and electronic characteristics of Dy-doped CoCr2O4, providing insights into its potential for energy storage applications.

FIG. 10 illustrates a Table depicting the weight amount of the composition for various concentrations in accordance with an embodiment of the present invention. The Table shows weight amount of the composition for various concentrations CoDyₓCr₂₋ₓO₄ (x=0, 0.01, 0.03 and 0.05).

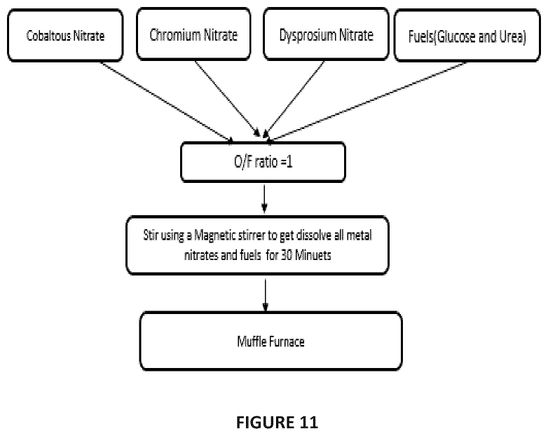

FIG. 11 illustrates a process flow of a method for synthesizing dysprosium-doped cobalt-chromate for supercapacitors applications in accordance with an embodiment of the present invention.

### Industrial Applications

Rb (Rubidium) doped CoCr2O4 (Cobalt Chromite) finds applications in various industrial sectors due to its unique properties. Here are some potential industrial applications:

1. Catalysis: Rb doped CoCr2O4 nanoparticles can be used as catalysts in various chemical reactions. Their high surface area and unique electronic structure make them efficient catalysts for processes such as Fischer-Tropsch synthesis, oxidation reactions, and hydrogenation reactions.

2. Gas Sensing: The electrical and structural properties of Rb doped CoCr2O4 make it suitable for gas sensing applications. It can be utilized in gas sensors for detecting gases such as hydrogen, carbon monoxide, and volatile organic compounds (VOCs). This is particularly useful in industrial settings where gas leaks need to be detected to ensure safety.

3. Magnetostrictive Materials: Cobalt Chromite-based materials exhibit magnetostrictive properties, meaning they change shape in response to an applied magnetic field. Rb doping can modify these properties for specific industrial applications such as in magnetostrictive transducers for sonar devices, sensors, and actuators.

4. Magnetic Recording Media: Cobalt-based materials are used in magnetic recording media, such as hard disk drives and magnetic tapes, due to their high magnetic coercivity and stability. Doping with Rb can further enhance these properties, leading to improved performance and storage density in data storage devices.

5. Solid Oxide Fuel Cells (SOFCs): Rb doped CoCr2O4 can be used as a cathode material in solid oxide fuel cells. Its high electrical conductivity, combined with good chemical stability and catalytic activity, makes it suitable for efficiently converting chemical energy into electrical energy in SOFCs.

6. Thermal Barrier Coatings (TBCs): Cobalt Chromite-based materials are also investigated for their potential applications in thermal barrier coatings. These coatings are used in gas turbine engines to protect underlying components from high-temperature environments. Rb doping can tailor the thermal and mechanical properties of these coatings for improved performance and durability.

7. Electrochemical Devices: Rb doped CoCr2O4 can be employed in various electrochemical devices such as lithium-ion batteries, supercapacitors, and electrochromic devices. Its conductivity and stability make it suitable for use as electrode materials, contributing to enhanced performance and longevity of these devices.

These are just a few examples of the industrial applications of Rb doped CoCr2O4. The versatility and tunable properties of this material make it promising for a wide range of technological advancements across different industries.

The disclosed method synthesizes dysprosium-doped cobalt-chromate by solution combustion synthesis method or Chemical synthesis method for supercapacitor applications. The disclosed method synthesizes nanomaterials on a large scale. The disclosed method is Cost-effective in preparing dysprosium-doped cobalt-chromate.

### Acknowledgement

The authors extend their appreciation to University Higher Education Fund for funding this research work under Research Support Program for Central labs at King Khalid University through the project number CL/RP/5.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A composition for synthesizing dysprosium-doped cobalt-chromate for supercapacitors applications, the composition comprises:
20.04-20.22 wt. % of cobaltous nitrate;
54.22-55.52 wt. % of chromium nitrate;
0-1.21 wt. % of Dysprosium nitrate;
13.88-13.13.91 wt. % of Urea; and
10.41-10.43 wt. % of Glucose.

2. The composition of claim 1, wherein the weight amount of the cobaltous nitrate, chromium nitrate, Dysprosium nitrate, Urea, and Glucose is 20.22%, 1.21%, 54.22%, 13.91%, and 10.43%, respectively.

3. A method for composition for synthesizing dysprosium-doped cobalt-chromate of claim 1, the method comprising:
dissolving oxidizers and fuels in 25 milliliters of distilled water in a glass beaker to form a solution, wherein the oxidizers include 20.04-20.22 wt. % of cobaltous nitrate, 54.22-55.52 wt. % of chromium nitrate, and 0-1.21 wt. % of Dysprosium nitrate, and the fuel includes 13.88-13.13.91 wt. % of urea and 10.41-10.43 wt. % of glucose;
stirring the solution for 40 minutes using a magnetic stirrer until the solution is dissolved upon maintaining an 800 rpm to form a green color homogeneous solution;
heating the homogeneous solution for 20-30 minutes in a box-type muffle furnace to obtain a green powder in the form of ash;
grounding the ash with mortar to form powder; and
drying particles of powder thereby agitating in an agate mortar and put through a grinding process that lasted one hour and resulted in the production of a fine green pigment of CoDyₓCr₂₋ₓO₄ (where, x=0, 0.03, 0.05).

4. The method of claim 3, further comprises forming an initial compound with nano-size crystallites, wherein the fuels help the oxidizers to catch fire in presence of suitable temperature, and wherein the homogeneous solution is heated at 450° C. to form an ash of green color, wherein the heating of the homogeneous solution for 20-30 minutes in a box-type muffle furnace is conducted under an inert atmosphere to minimize oxidation and ensure the purity of synthesized CoDyₓCr₂₋ₓO₄ nanoparticles, wherein dissolution of oxidizers and fuels in 25 milliliters of distilled water is carried out at room temperature to ensure proper mixing and solubility, and wherein a user-defined quantity of a ground mixture is compressed under pressure in a hydraulic press to achieve pelletization, and wherein a size of the fine green pigment material is preferably 25 nm.

5. The method of claim 3, wherein a solution combustion technique is used to produce the fine green pigment of CoDyₓCr₂₋ₓO₄, and wherein the grinding of the ash with mortar is followed by sieving to achieve a desired particle size distribution of the CoDyₓCr₂₋ₓO₄ powder, and wherein the solution combustion technique involves maintaining the solution at a temperature range of 250° C. to 300° C. during the combustion process, promoting a controlled exothermic reaction between the oxidizers and fuels, and wherein the sieving process is carried out using a series of progressively finer mesh screens ranging from 50 μm to 10 μm to ensure a uniform particle size distribution of CoDyₓCr₂₋ₓO₄, with a final particle size of less than 25 nm.

6. The method of claim 3, wherein the CoDyₓCr₂₋ₓO₄ nanoparticles are further modified or functionalized through post-synthesis treatments to enhance specific capacitance, cycling stability, and rate capability for improved supercapacitor performance, and wherein the stirring process of the solution for 40 minutes is performed with a variable-speed magnetic stirrer that automatically adjusts its rotational speed between 750 rpm and 800 rpm to maintain consistent homogeneity, further comprising monitoring the pH of the solution throughout the stirring process to ensure the optimal conditions for combustion synthesis.

7. The method of claim 3, further comprising the step of pre-heating the glass beaker containing the solution at a temperature range of 50° C. to 60° C. prior to heating in the box-type muffle furnace, wherein the pre-heating step promotes the evaporation of excess water to increase the concentration of the oxidizers and fuels, thereby improving the combustion efficiency during the synthesis of CoDyₓCr₂₋ₓO₄, and wherein the box-type muffle furnace is equipped with a programmable temperature controller that gradually increases the temperature from room temperature to 450° C. over a period of 15 minutes, thereby minimizing thermal shock to the solution and promoting uniform combustion throughout the solution volume.

8. The method of claim 7, wherein the pre-heating of the glass beaker at 50° C. to 60° C. is performed using a laboratory hotplate with precise temperature control, wherein the solution is continuously stirred during pre-heating to prevent localized supersaturation of the oxidizers and ensure uniform precursor distribution prior to combustion, and wherein the magnetic stirrer used for stirring the solution is equipped with a temperature probe and feedback loop, automatically adjusting the stirring speed to maintain a constant solution viscosity, thus preventing phase separation or the formation of precipitates during the dissolution of the oxidizers and fuels.

9. The method of claim 4, wherein the user-defined quantity of the ground mixture is subjected to a multi-step compression process in the hydraulic press, with each step involving an incremental increase in pressure from 5 MPa to 15 MPa, followed by a cooling period between each compression step to improve the structural integrity of the resulting pellets, and wherein the solution is prepared in a controlled environment chamber that maintains a humidity level below 10% to prevent moisture interference with the oxidizers and fuels, thereby ensuring consistency in the combustion reaction during the synthesis of CoDyₓCr₂₋ₓO₄.

10. The method of claim 3, wherein the 25 nm size of the fine green pigment material is achieved by performing a multi-stage grinding process, each stage involving different mesh sizes of the agate mortar to sequentially reduce particle size, followed by air jet milling to achieve a uniform nanoparticle distribution with minimal agglomeration, and wherein the green ash formed in the muffle furnace is subjected to a post-synthesis annealing process in a tube furnace at a temperature of 500° C. under a reducing hydrogen atmosphere for 2 hours, enhancing the crystalline structure and reducing any remaining oxidized impurities in the CoDyₓCr₂₋ₓO₄ nanoparticles.

11. The method of claim 10, wherein the post-synthesis treatment includes functionalizing the CoDyₓCr₂₋ₓO₄ nanoparticles with carbon nanotubes (CNTs) via a wet chemical method, where the functionalization process is performed in an ultrasonicator bath for 60 minutes, thereby enhancing the electrochemical properties of the nanoparticles for improved energy storage applications, and wherein the homogeneous solution is heated at 450° C. in a muffle furnace with a controlled heating ramp rate of 5° C. per minute, ensuring that thermal decomposition of the oxidizers occurs uniformly, thereby minimizing the formation of unwanted byproducts during the synthesis of CoDyₓCr₂₋ₓO₄.

12. The method of claim 5, wherein the sieving process following the grinding of the ash is performed using a series of stainless steel sieves with decreasing mesh sizes from 100 μm to 25 μm, wherein the powder is passed through each sieve under vacuum conditions to minimize contamination and achieve a uniform particle size distribution, and wherein the annealing process in the tube furnace is carried out in a reducing atmosphere of 5% hydrogen and 95% argon, with a controlled gas flow rate of 50 sccm, ensuring that any residual oxygen in the CoDyₓCr₂₋ₓO₄ nanoparticles is fully reduced, thereby enhancing the phase purity of the final product.

13. The method of claim 12, wherein the sieving is conducted in a glove box under a nitrogen atmosphere to prevent exposure of the CoDyxCr2−xO4 powder to ambient air, thereby minimizing oxidation and ensuring the preservation of the material's phase purity during the sieving process.

14. The method of claim 12, wherein the grinding process includes an intermediate heating step, wherein the ground powder is heated to 150° C. for 30 minutes between each grinding stage to eliminate moisture and prevent agglomeration of nanoparticles, ensuring a consistent reduction in particle size at each stage, and wherein the 40-minute stirring process is followed by a rest period of 10 minutes at room temperature, during which the solution is allowed to settle, promoting complete dissolution of any remaining solid particles and ensuring uniform precursor distribution before heating.

15. The method of claim 11, wherein the functionalization of the CoDyₓCr₂₋ₓO₄ nanoparticles is performed by covalently attaching amino-functional groups to the nanoparticle surface using a silanization process, wherein the nanoparticles are suspended in ethanol and treated with 3-aminopropyltriethoxysilane (APTES) under nitrogen atmosphere for 2 hours at 60° C., enhancing the material's supercapacitor performance, and wherein the cobaltous nitrate, chromium nitrate, and dysprosium nitrate are dissolved in the distilled water in a sequential manner, with each nitrate being added incrementally over a period of 5 minutes while stirring, ensuring proper solubility of each nitrate before adding the next to avoid precipitation or unwanted side reactions.

16. The method of claim 4, wherein the ground mixture is compressed in a hydraulic press using a multi-stage process, where the pressure is applied in incremental steps of 2 MPa, pausing for 5 seconds between each pressure increase, to avoid micro-cracking of the pellets and to achieve a uniform pellet density.

17. The method of claim 11, wherein the wet chemical method used to functionalize the CoDyₓCr₂₋ₓO₄ nanoparticles with carbon nanotubes involves a two-step process, wherein the nanoparticles are first coated with a polydopamine layer in an alkaline solution under magnetic stirring, followed by the attachment of the carbon nanotubes through π-π stacking interactions, enhancing the conductivity of the final material.

18. The method of claim 3, wherein the heating of the homogeneous solution in the box-type muffle furnace is conducted in a stepwise manner, starting at 150° C. for 10 minutes to evaporate excess water, followed by an increase to 450° C. over the next 20 minutes, ensuring gradual combustion and reducing thermal stress on the solution during the synthesis of CoDyₓCr₂₋ₓO₄.

19. The method of claim 4, wherein the fine green pigment material of CoDyₓCr₂₋ₓO₄, having a particle size of 25 nm, is subjected to an additional ball milling process for 2 hours, using zirconia balls under nitrogen atmosphere, to achieve enhanced uniformity in particle size distribution and prevent oxidation during the milling process.
